(19) United States
(12) Patent Application Publication
(10) Pub. No.: US 2009/0092458 A1
(43) Pub. Date: Apr. 9, 2009

(54) SELF-DRILLING ANCHOR

(75) Inventors: Geoffery John Moroney, Canning Vale (AU); Sean Jarratt Fitzgerald, Aubin Grove (AU)

Correspondence Address: Workman Nydegger;1000 Eagle Gate Tower, 60 East South Temple, Salt Lake City, UT, 84111, US

(73) Assignee: Longyear TM, Inc., Salt Lake City, UT (US)

(21) Appl. No.: 12/210,916

(22) Filed: Sep. 15, 2008

Related U.S. Application Data
(60) Provisional application No. 60/972,541, filed on Sep. 14, 2007.

(51) Int. Cl. F16B 13/06

(52) U.S. Cl. 411/29

(57) ABSTRACT

An embodiment of the invention includes a self-drilling anchor. The self-drilling anchor includes a drill rod with a first end and a second end and a drill bit attached to the first end of the drill rod. The self-drilling anchor also includes an expansion shell located over the drill rod near the first end and adjacent to the drill bit and a rod sleeve located over the drill rod and adjacent to the expansion shell.

### CROSS-REFERENCE TO RELATED APPLICATIONS

This application claims the benefit of and priority to U.S. Provisional Patent Application Ser. No. 60/972,541 filed on Sep. 14, 2007, which application is incorporated herein by reference in its entirety.

### BACKGROUND OF THE INVENTION

In drilling, mining, tunneling and other various operations it is often necessary to anchor the equipment used so that it does not move when it is operated. Likewise, it is often necessary to support or reinforce rock and soil against collapsing, slumping or sliding during excavations. Excavating equipment that is inadequately anchored and rock that is inadequately supported can result in inefficiencies and safety hazards.

Conventionally, anchoring and support systems have been installed by first drilling into the medium where the anchor or bolt is desired. Then, after removing the drill rod, an anchor or bolt is secured into the hole. There exist several drawbacks to the current designs of anchors. Current anchors are fairly complex and include specialized parts which are costly to manufacture and difficult to use. Current anchors also require grout, epoxy or some other adhesive to secure them in place. Finally, current anchors are not designed to be removed from the medium in which they are installed after they are no longer required, resulting in significant waste and safety hazards.

### BRIEF SUMMARY OF THE INVENTION

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

An embodiment of the invention includes a self-drilling anchor. The self-drilling anchor includes a drill rod with a first end and a second end and a drill bit attached to the first end of the drill rod. The self-drilling anchor also includes an expansion shell located over the drill rod near the first end and adjacent to the drill bit and a rod sleeve located over the drill rod and adjacent to the expansion shell.

Another embodiment of the invention includes a method for assembling a self-drilling anchor. The method includes providing a drill rod having a first end and a second end and attaching a drill bit to the first end of the drill rod. The method also includes locating an expansion shell over the drill rod near the first end and adjacent to the drill bit and locating a rod sleeve over the drill rod and adjacent to the expansion shell.

Another embodiment of the invention includes a method for installing a self-drilling anchor. The method includes assembling a self-drilling anchor, driving the self-drilling anchor to a desired depth in a medium and securing the self-drilling anchor at the desired depth.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates some components that can be used to form a self-drilling anchor;

FIG. 2 illustrates some auxiliary components that can be used in conjunction with the self-drilling anchor;

FIG. 3 is a flow diagram illustrating a method for assembling a self-drilling anchor;

FIG. 4 illustrates a self-drilling anchor being assembled;

FIG. 5 is a flow diagram illustrating a method for installing a self-drilling anchor;

FIG. 6 illustrates a self-drilling anchor being driven into a medium;

FIG. 7 illustrates a self-drilling anchor being secured in a medium;

FIG. 8 is a flow diagram illustrating a method for retaining a self-drilling anchor;

FIG. 9 illustrates a self-drilling anchor that has been retained;

FIG. 10 is a flow diagram illustrating a method for removing some of the components of the self-drilling anchor; and

FIG. 11 shows a self-drilling anchor in which the retaining mechanism, drill rod and rod sleeve have been removed.

### DETAILED DESCRIPTION OF THE PREFERRED EMBODIMENTS

According to the embodiments disclosed herein, a self-drilling anchor is described which is easy to use and is more cost effective than conventional anchors. The self-drilling anchor may be secured without the use of grout, epoxy or some other adhesive to secure the self-drilling anchor in place. In addition, the self-drilling anchor may be installed in a medium which is either loose material, such as loose rock or gravel, solid material, such as solid rock or concrete, or a medium that is solid, with a layer of loose overburden over the top of the solid portion. Additionally, some components of the self-drilling anchor can be removed from the medium in which it is installed after they are no longer required, resulting in reduced waste and increased safety.

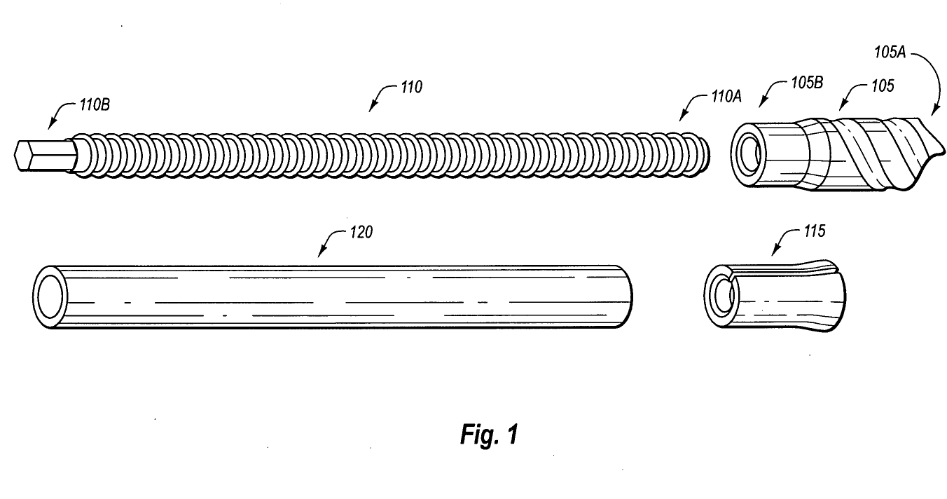

FIG. 1 illustrates an example of some components that can be used to form a self-drilling anchor. One component shown is a drill bit 105, which has a cutting head 105A and a shank 105B. In some embodiments, the shank 105B can contain an internal thread or can be a quick connect, a brace shank, straight shank, hex shank, SDS shank, triangle shank, morse taper shank, or any other mechanism which allows for connection to a component or device for supplying torque, thrust, or both. Additionally, the type of shank 105B can be chosen to allow the drill bit 105 to be disconnected from other components of the self-drilling anchor as described below. In some embodiments, the shank 105B can be tapered. The degree of the taper can range from about 5 to about 25 degrees relative to the axis of the drill bit 105 or can be any other value to allow for the proper installation of the other components of the self-drilling anchor to be described below. In some embodiments, the cutting head 105A of the drill bit 105 may have a larger diameter than the other components to ensure that the other components can be inserted into the drilled hole at the appropriate time as described below.

The cutting head 105A of the drill bit 105 can be made of any material designed to properly penetrate a medium into which the self-drilling anchor will be installed, including low carbon steel, high carbon steel, high speed steel, cobalt steel, tungsten carbide, polycrystalline diamond, or any other appropriate material. In addition, the drill bit 105 may be coated with black oxide, titanium nitride (TiN), titanium aluminum nitride (TiAN), titanium carbon nitride (TiCN), diamond powder, zirconium nitride, or any other material which will provide the required characteristics. Additionally, the shape and size of the drill bit 105 can be any appropriate shape or size to create a hole of the desired shape and diameter.

Also shown in FIG. 1 is a drill rod 110. The drill rod 110, as shown, has substantially uniform threads disposed along part of its length and its first end 110A, or the end to which the drill bit 105 can be connected. In other embodiments, the drill rod 110 can have threads over all or none of its length. The threads may be right-handed or left-handed and may have whatever pitch is necessary to connect to the drill bit 105 or any other component to be connected to the first end 110A or the second end 110B of the drill rod 110. For example, the thread size can be R25 or any other size. Additionally, the first end 110A of the drill rod 110 can be configured to mate with a quick connect, a brace shank, straight shank, hex shank, SDS shank, triangle shank, morse taper shank, or any other mechanism which allows connection to a component, such as a drill bit 105, and allows transfer of torque, thrust, or both.

As shown, on the second end 110B of the drill rod 110 is a hex driver for connecting the drill rod 110 to a drill or other device for providing torque, thrust, or both. In other embodiments, the second end 110B of the drill rod 110 can be threaded or can have a brace shank, straight shank, SDS shank, triangle shank, morse taper shank, or any other mechanism which allows the drill rod 110 to be connected to a drill, or other mechanical device, for supplying torque, thrust, or both. For example, in one embodiment the second end 110B of the drill rod 110 is threaded

The drill rod 110 may be made of any material including steel, stainless steel, titanium, brass, bronze, silicon bronze, MONEL®, aluminum, plastic or any other material suitably strong to transfer torque, thrust, or both, to the drill bit 105 and to ensure that the drill rod can withstand the longitudinal stresses involved in using the self-drilling anchor. Additionally, the drill rod 110 may be coated in brass, zinc, chromium, or any other material which will provide additional strength to the drill rod 110 or provide other desired characteristics. In some embodiments, parts of the drill rod 110 may be coated with an epoxy or any other corrosion resistant coating that does not interfere with the function of the threads or other features.

Another component shown in FIG. 1 is an expansion shell 115. The expansion shell 115 as shown is substantially hollow such that it fits over the outside diameter of the drill rod 110. In some embodiments, the expansion shell 115 may be split along all or part of its length so that the expansion shell 115 can expand radially when wedged between the drill bit 105 and the medium in which the self-drilling anchor is being installed, as described below. In other embodiments, the expansion shell 115 can have pre-machined fracture points, can be made in two halves, be made of a ductile material or can be fashioned in any other manner which will allow radial expansion. Additionally, the expansion shell 115 may be flared at one end, to allow the expansion shell 115 to more easily be wedged between the drill bit 105 and the medium in which the self-drilling anchor is being installed.

The expansion shell 115 may be made of any material that is ductile enough to allow the expansion shell 115 to expand, but strong enough to prevent the expansion shell 115 from being damaged or warped beyond use when force is applied. In some embodiments, such materials can include steel, stainless steel, titanium, brass, bronze, silicon bronze, MONEL®, aluminum, plastic or any other material that has the desired characteristics.

The length of the expansion shell 115 depends on the medium in which the anchor is to be secured, the force that the anchor will be required to resist, and other factors. In some embodiments, the more force that the self-drilling anchor must resist in order to prevent the anchor from being pulled from its secure position, the longer the expansion shell 115 can be. The increased length can provide a greater amount of friction to resist removal of the self-drilling anchor. In other embodiments, if the medium is loose, such as loose rock or gravel, the expansion shell 115 can be longer than if the medium is a solid material, such as solid rock or concrete. The increased length will provide a greater surface area, which will, in turn, provide a greater amount of friction to resist removal of the self-drilling anchor.

While the expansion shell 115 is shown as having a substantially smooth surface, either the inner surface, outer surface, or both surfaces of the expansion shell 115 may be textured to increase friction along the surface. The texture can include ridges, nodules, edges, points, crests, teeth, rims, creases, bumps, swells or any other texturing feature designed to provide the desired amount of friction. Additionally, a coating, such as spray metal, may be applied to the inner surface, outer surface, or both surfaces, to increase the friction along the surface of the expansion shell 115.

Also shown in FIG. 1 is a rod sleeve 120. The rod sleeve 120 as shown is hollow and has a sufficiently large inner diameter to allow the rod sleeve 120 to fit over the outside diameter of the drill rod 110. The rod sleeve 120 is configured to both keep open the hole being drilled and to transfer force to the expansion shell 115. This transfer of force wedges the expansion shell 115 between the drill bit 105 and the medium into which the self-drilling anchor is installed. The rod sleeve 120 can be given any configuration, including the configuration shown in FIG. 1, which allows it to perform this function. In some embodiments, the rod sleeve 120 can be a single piece or can be multiple pieces which together perform the equivalent function. The rod sleeve 120 may be long enough to cover the entire drill rod 110 or only a portion thereof.

The rod sleeve 120 can be made of steel, stainless steel, titanium, brass, bronze, silicon bronze, MONEL®, aluminum, plastic or any other material that is sufficiently rigid to allow the rod sleeve 120 to transfer force to the expansion shell 115 and force the expansion shell 115 between the drill bit 105 and the medium into which the self-drilling anchor is installed. Additionally, the rod sleeve 120 may be coated in brass, zinc, chromium, or any other material which will provide additional strength to the rod sleeve 120 or provide other desired characteristics. The rod sleeve 120 may be coated with an epoxy or any other corrosion resistant material to prevent corrosion or other degradation of the rod sleeve 120 while remaining in the hole. In some embodiments, the rod sleeve 120 may remain in the hole while the self-drilling anchor is used to secure equipment or left in the hole for any other reason. In other embodiments, the rod sleeve 120 may be removed while the self-drilling anchor is being used.

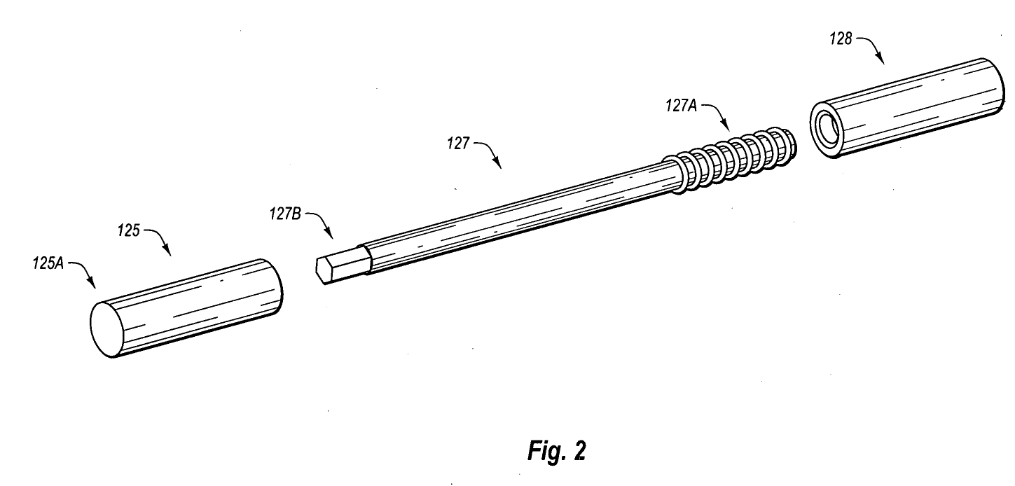

FIG. 2 illustrates some example auxiliary components that may be used in conjunction with the self-drilling anchor. One of these auxiliary components is a drive sleeve 125. The drive sleeve 125 can be configured to transfer force to the rod sleeve 120 which in turn will transfer force to the expansion shell 115, wedging the expansion shell 115 between the drill bit 105 and the medium into which the self-drilling anchor is being secured. In some embodiments, the drive sleeve 125 can be hollow and of sufficient length to cover the portion of the drill rod 110 that is not covered by the rod sleeve 120 or expansion shell 115. In other embodiments, the drive sleeve 125 can be of sufficient length to extend beyond the end of the drill rod 110 when abutting the rod sleeve 120. In further embodiments, the drive sleeve 125 can be hollow with one closed end 125A and configured to fit over the end of the rod sleeve 120. The drive sleeve 125 can have one closed end 125A such that force can be applied to the closed end 125A of the drive sleeve 125 and transmitted to the rod sleeve 120. Closing the end 125A can prevent warping or distortion of the drive sleeve 125 when force is applied.

The drive sleeve 125 can be made of steel, stainless steel, titanium, brass, bronze, silicon bronze, MONEL®, aluminum, plastic or any other material that is sufficiently rigid to allow the drive sleeve 125 to transfer force to the rod sleeve 120, which in turn transfers the force to the expansion shell 115 and wedges the expansion shell 115 between the drill bit 105 and the medium into which the self-drilling anchor is installed. Additionally, the drive sleeve 125 may be coated in brass, zinc, chromium, or any other material which will provide additional strength to the drive sleeve 125 or provide other desired characteristics. In addition, the shape of the drive sleeve 125 can be configured to maximize the transfer of force to the rod sleeve 120.

Another auxiliary component illustrated in FIG. 2 is a converter 127. The converter 127 can change one type of driver to another. For example, the converter 127 as shown has threading on its first end 127A, and a hex driver on its second end 127B. The threading allows the converter 127 to be connected to the second end 127B of the drill rod 110 for transmission of torque, thrust, or both, to the drill rod 110. In some embodiments, the converter 127 may have internal threads on the end to be connected to the drill rod 110, if the drill rod 110 is threaded, such that the converter 127 can be threaded onto the drill rod 110. Alternatively, the first end 127A can be configured to mate with a quick connect, a brace shank, straight shank, hex shank, SDS shank, triangle shank, morse taper shank, or any other mechanism which allows connection to the driver of the drill rod 110, or any other component and allows transfer of torque, thrust, or both.

In some embodiments, the second end 127B of the converter 127 can be configured to be inserted or otherwise attached to a drill, or other device, which is configured to produce the required torque, thrust, or both, for driving the self-drilling anchor to the desired depth. In some embodiments, the driver can be a quick connect, a brace shank, straight shank, hex shank, SDS shank, triangle shank, morse taper shank, an eyelet, a hook, a platform or any other mechanism which allows for connection to a drill or other device configured to produce torque, thrust, or both. In addition, the converter 127 can be made of steel, stainless steel, titanium, brass, bronze, silicon bronze, MONEL®, aluminum, plastic or any other material that is sufficiently rigid to allow for the transmission of torque, thrust, or both, from the drill to the drill rod 110. Additionally, the converter 127 may be coated in brass, zinc, chromium, or any other material which will provide additional strength to the converter 127 or provide other desired characteristics.

Also shown in FIG. 2 is a coupling 128. The coupling 128 can be used to connect or couple the converter 127 to the drill rod 110. The coupling 128 may be made of steel, stainless steel, titanium, brass, bronze, silicon bronze, MONEL®, aluminum, plastic or any other suitable material. Additionally, the coupling 128 may be coated in brass, zinc, chromium, or any other material which will provide additional strength to the coupling 128 or provide other desired characteristics. The coupling 128 can contain an internal thread such that the coupling 128 can be threaded onto or connect to the second end 110B of the drill rod 110, or can be of any other shape or configuration that allows for connection to the second end 110B of the drill rod 110. The other end of the coupling 128 can likewise be threaded or have any other shape or configuration to connect to the converter 127 or to any other desired component.

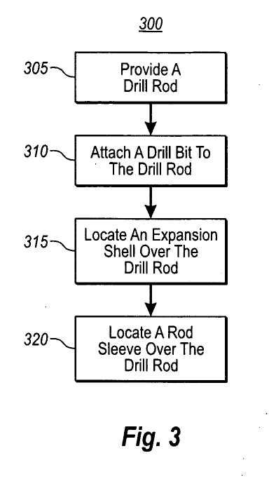

FIG. 3 illustrates an example of a method 300 for assembling a self-drilling anchor. The method 300 may be used to assemble the self-drilling anchor of FIG. 1; therefore, the method 300 will be explained in relation to the self-drilling anchor of FIG. 1. Note, however, that the self-drilling anchor of FIG. 1 is only one of many self-drilling anchors that may implement the method 300.

The method 300 includes providing 305 a drill rod, such as drill rod 110. The drill rod 110 can have threads over all or part of its length including the first end 110A and second end 110B. The threads may be right-handed or left-handed and may have whatever pitch is necessary to connect to the drill bit 105 or any other component to be connected to the first end 110A of the drill rod 110. For example, the thread size could be R25 or any other size. Additionally, the first end 110A of the drill rod 110 can be configured to mate with a quick connect, a brace shank, straight shank, hex shank, SDS shank, triangle shank, morse taper shank, or any other mechanism which allows connection to a component, such as a drill bit 105, and allows transfer of torque, thrust, or both.

In some embodiments, the drill rod 110 may have a hex driver on its second end 110B for connecting the drill rod 110 to a drill or other device for providing torque, thrust, or both. In other embodiments, the second end 110B of the drill rod 110 can be threaded or can have a brace shank, straight shank, SDS shank, triangle shank, morse taper shank, or any other mechanism which allows the drill rod 110 to be connected to a drill or other mechanical device for supplying torque, thrust, or both.

The method 300 also includes attaching 310 a drill bit, such as drill bit 105, to the drill rod 110. The drill bit 105 has a cutting head 105A and a shank 105B. In some embodiments, the shank 105B can contain an internal thread or can be a quick connect, a brace shank, straight shank, hex shank, SDS shank, triangle shank, morse taper shank, or any other mechanism which allows for connection to the drill rod 110 or other device for supplying torque, thrust, or both. Additionally, the type of shank 105B can be chosen to allow the drill bit 105 to be disconnected from the drill rod 110 or other device as described below. In some embodiments, the shank 105B can be tapered. The degree of the taper can range from about 5 to about 25 degrees relative to the axis of the drill bit 105 or can be any other value to allow for the proper installation of the other components of the self-drilling anchor to be described below. In some embodiments, the head 105A of the drill bit 105 may have a larger diameter than the other components to ensure that the other components can be inserted into the drilled hole when necessary to be described below.

The method 300 further includes locating 315 an expansion shell, such as expansion shell 115, over the drill rod 110. The expansion shell 115 can be located adjacent to the drill bit 105. Adjacent is defined as situated near or next to. Therefore, the expansion shell 115 can be near to, but not necessarily touching, the drill bit 105, or the expansion shell 115 can abut the drill bit 105. The expansion shell 115 is substantially hollow such that it fits over the outside diameter of the drill rod 110. In some embodiments, the expansion shell 115 may be split along all or part of its length so that the expansion shell 115 can expand radially when wedged between the drill bit 105 and the medium in which the self-drilling anchor is being installed, as described below. In other embodiments, the expansion shell 115 can have pre-machined fracture points, can be made in two halves, be made of a ductile material or can be fashioned in any other manner which will allow radial expansion. Additionally, the expansion shell 115 may be flared at one end, to allow the expansion shell 115 to more easily be wedged between the drill bit 105 and the medium in which the self-drilling anchor is being installed.

In some embodiments, the expansion shell 115 has a substantially smooth surface. In other embodiments, either the inner surface, outer surface, or both surfaces of the expansion shell 115 may be textured to increase friction along the surface. The texture can include ridges, nodules, edges, points, crests, teeth, rims, creases, bumps, swells or any other texturing feature designed to provide the desired amount of friction. Additionally, a coating, such as spray metal, may be applied to the inner surface, outer surface, or both surfaces, to increase the friction along the surface of the expansion shell 115.

The method 300 also includes locating 320 a rod sleeve 120 over the drill rod 110. The rod sleeve 120 can be located adjacent to the expansion shell 115. Therefore, the rod sleeve 120 can be near to, but not necessarily touching, the expansion shell 115 or the rod sleeve 120 can abut the expansion shell 115.

The rod sleeve 120 can be hollow and have a sufficiently large inner diameter to allow the rod sleeve 120 to fit over the outside diameter of the drill rod 110. The rod sleeve 120 is configured to both keep open the hole being drilled, if necessary, and to transfer force to the expansion shell 115. This transfer of force wedges the expansion shell 115 between the drill bit 105 and the medium into which the self-drilling anchor is installed. The rod sleeve 120 can be given any configuration that allows it to perform this function. In some embodiments, the rod sleeve 120 can be a single piece or can be multiple pieces which together perform the equivalent function. The rod sleeve 120 may be long enough to cover the entire drill rod 110 or only a portion thereof.

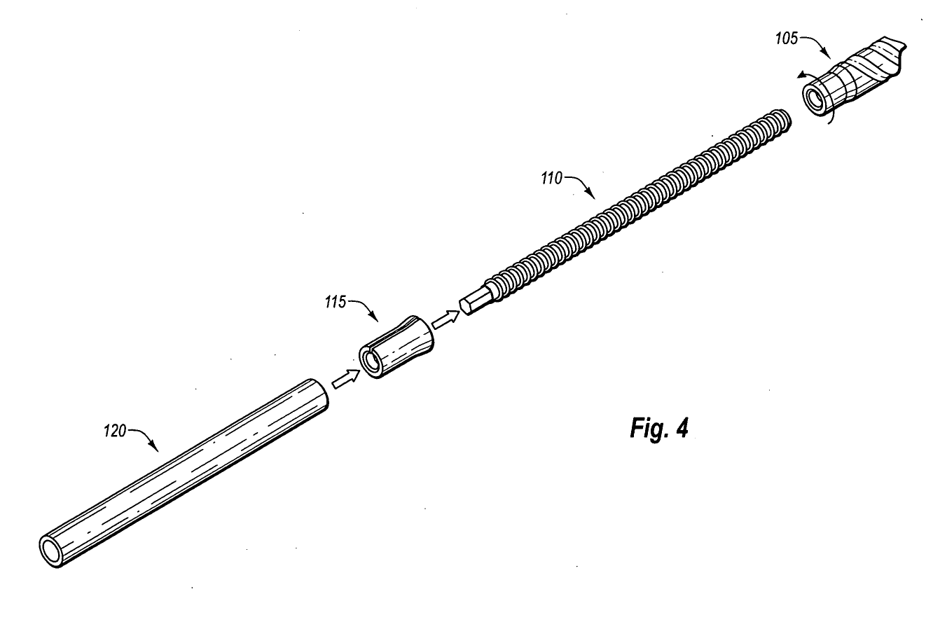

FIG. 4 illustrates an example of assembling a self-drilling anchor. The drill bit 105 is screwed, or otherwise attached, to the drill rod 110. If the rotation of the drill bit 105 when drilling is clockwise, the threading of the drill rod 110 can be right-handed, so that the drill bit 105 tightens onto the drill rod 110 during the drilling operation used to create the drill hole. If the rotation of the drill bit 105 when drilling is counterclockwise, then the threading of the drill rod 110 can be left-handed, so that the drill bit 105 tightens onto the drill rod 110 during the drilling operation used to create the drill hole. An expansion shell 115 is located over the drill rod 110. The expansion shell 115 is slid to a position that is adjacent to the drill bit 105. A rod sleeve 120 is located over the drill rod 110 and slid to a position adjacent to the expansion shell 115.

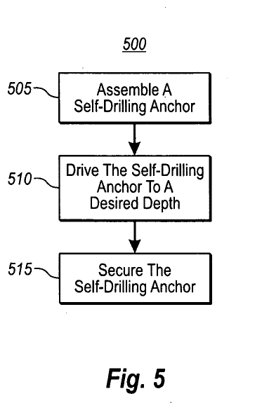

FIG. 5 illustrates an example of a method 500 for installing a self-drilling anchor. The method 500 may be used to install the self-drilling anchor of FIGS. 1 and 4; therefore, the method 500 will be explained in relation to the self-drilling anchor of FIGS. 1 and 4. Note, however, that the self-drilling anchor of FIGS. 1 and 4 is only one of many self-drilling anchors that may implement the method 500.

The method 500 includes assembling 505 a self-drilling anchor. The drill bit 105 is screwed, or otherwise attached, to the drill rod 110. If the rotation of the drill bit 105 when drilling is clockwise, the threading of the drill rod 110 can be right-handed, so that the drill bit 105 tightens onto the drill rod 110 during the drilling operation used to create the drill hole. If the rotation of the drill bit 105 when drilling is counterclockwise, then the threading of the drill rod 110 can be left-handed, so that the drill bit 105 tightens onto the drill rod 110 during the drilling operation used to create the drill hole. An expansion shell 115 is located over the drill rod 110. The expansion shell 115 is slid to a position that is adjacent to the drill bit 105. A rod sleeve 120 is located over the drill rod 110 and slid to a position adjacent to the expansion shell 115.

The method 500 also includes driving 510 the self-drilling anchor to a desired depth in the medium into which the self-drilling anchor is being installed. Driving 510 the self-drilling anchor may be accomplished by using a drill or other appropriate device to provide torque, thrust, or both, to the drill bit 105 through the drill rod 110, driving the drill bit 105 into the medium. The desired depth will depend on the material into which the self-drilling anchor is driven, the length of the drill rod 110, the force that the anchor will be required to resist, and other factors. Additionally, the length of drill rod 110 left exposed may be controlled to minimize the amount of the self-drilling anchor that will be exposed after final installation. Such minimization can increase safety and minimize damage to equipment or other materials, such as tires if the self-drilling anchor is installed on a road bed.

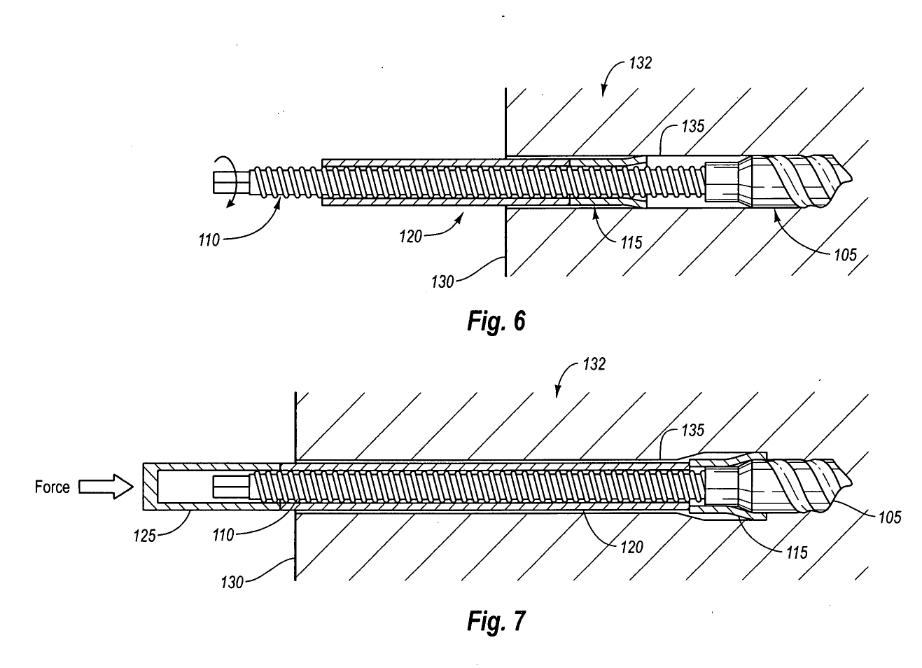

FIG. 6 illustrates an example of a self-drilling anchor being driven into a medium. Torque, thrust, or both, are provided to the driver of the drill rod 110 by a drill or other appropriate device. The torque, thrust or both are transferred to the drill bit 105 via the connection between the drill rod 110 and drill bit 105. The drill bit 105 cuts through the surface 130 of the medium 132 and creates a drill hole 135. In addition, the grooves or spiral of the drill bit 105 can pull the drill bit 105 further into the medium 132, which can convert torque to thrust. The pull of the drill bit 105 causes the rest of the self-drilling anchor to be pulled into the drill hole 135. This allows the self-drilling anchor to be driven to the appropriate depth.

In some embodiments, the expansion shell 115 and rod sleeve 120 have a smaller outer diameter than the diameter of the cutting head of the drill bit 105. This allows the expansion shell 115 and rod sleeve 120 to slip into the hole 135 easily. As the expansion shell 115 and rod sleeve 120 follow the drill bit 105 into the hole 135, they can also serve to keep the hole 135 open if the medium 132 is composed of loose material, such as loose rock or gravel. In alternative embodiments, the expansion shell 115, the rod sleeve 120, or both, can be located over the drill rod 110 after the drill rod 110 and drill bit 105 have been driven to the appropriate depth. For example, if the medium 132 is composed of solid material and there is little or no danger of obstruction to the hole 135 during drilling, the expansion shell 115, rod sleeve 120, or both, can be located over the drill rod 110 after drilling to minimize the components used during the drilling operation. In other embodiments, the expansion shell 115, rod sleeve 120, or both can be located over the drill rod 110 after drilling to minimize damage done to the expansion shell 115 and rod sleeve 120 and preserve them for the securing operation.

Returning to FIG. 5, the method 500 further comprises securing 515 the self-drilling anchor. In some embodiments the self-drilling anchor can be secured by wedging the expansion shell 115 between the drill bit 105 and the medium into which the self-drilling anchor is to be secured. The expansion shell 115 can be wedged between the drill bit 105 and the medium by applying a force to the expansion shell 115. The force can be supplied via the rod sleeve 120, which can be driven against the expansion sleeve. In some embodiments, the force can be applied directly to the rod sleeve 120. In other embodiments, a drive sleeve 125 can be located over the exposed end of the drill rod 110 and a force can be applied to the drive sleeve 125. In further embodiments, if the rod sleeve 120 extends beyond the end of the drill rod 110, the drive sleeve 125 can be located directly over the rod sleeve 120. The force can be applied either by manual labor with a tool such as a sledge hammer or other tool used for the manual application of force. Alternatively, the force can be applied using any known powered equipment, such as a hydraulic cylinder. Powered equipment can be used when a known force is desired.

FIG. 7 illustrates an example of securing a self-drilling anchor in a medium 132. A force is applied to the drive sleeve 125. The force is transferred to the rod sleeve 120 and then to the expansion shell 115. The force wedges the expansion shell 115 between the drill bit 105 and the medium 132 securing the self-drilling anchor. The frictional forces between the medium 132, the expansion shell 115 and the drill bit 105 prevent removal of the self-drilling anchor.

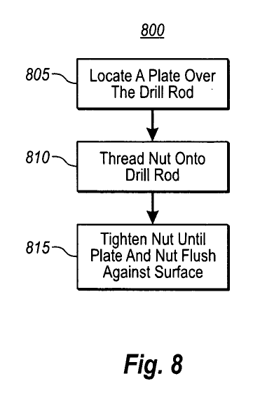

FIG. 8 illustrates an example of a method 800 for retaining a self-drilling anchor. The method 800 may be used to retain the self-drilling anchor of FIGS. 1 and 7; therefore, the method 800 will be explained in relation to the self-drilling anchor of FIGS. 1 and 7. Note, however, that the self-drilling anchor of FIGS. 1 and 7 is only one of many self-drilling anchors that may implement the method 800.

The method 800 includes locating 805 a plate over the drill rod, such as drill rod 110. The plate can be a separate component or can be part of another piece of equipment. The plate will sit flush, or nearly flush, against the surface 130 of the medium 132. The plate can provide a flat surface for the other retaining elements. The plate can also prevent the drill rod 110 from moving. Within the drill hole 135, the rod sleeve 120, if present, may prevent lateral movement. However, the rod sleeve 120 may not extend to the surface. In some embodiments, the diameter of the hole 135 in the plate is nearly the same as the outside diameter of the drill rod 110, preventing movement of the drill rod 110 with respect to the plate. In other embodiments, the plate can contain a complementary hole 135 to the shape of the drill rod 110, allowing the plate to be fit tightly around the drill rod 110. For example, the plate can have threading which allows the plate to be threaded onto the drill rod 110. Once the plate is secured, friction between the plate and the surface 130 of the medium 132 will prevent movement of the plate, which in turn prevents lateral movement of the drill rod 110.

The method 800 also includes threading 810 a nut onto the drill rod 110 and tightening 815 the nut until the nut is flush, or nearly flush, against the plate and the plate is flush, or nearly flush, against the surface 130 of the medium 132. Tightening 815 the nut can prevent lateral movement of the self-drilling anchor. Frictional forces between the plate and the surface 130 of the medium 132, and the nut and the plate, can prevent movement of the drill rod 110. Additionally, tightening 815 the nut can make the anchor more secure. As the nut is tightened against the plate, the forces involved will pull the drill rod 110 out of the hole 135 if the anchor has not been secured well. This will, in turn, pull the drill bit 105 more securely into the expansion shell 115. If the expansion shell 115 slides with the drill bit 105, the expansion shell 115 may eventually pull into the rod sleeve 120, which will, in turn, pull into the plate, preventing further sliding. The result will be the expansion shell 115 more firmly wedged between the drill bit 105 and the medium 132, making the self-drilling anchor more secure.

In some embodiments, a second nut can be threaded onto the drill rod 110 and tightened against the first nut, acting as a lock nut. Alternatively, other attachments, such as a hook, an eyelet, or any other attachment can be threaded or otherwise attached to the protruding end of the drill rod 110 either to serve as a locking mechanism, such as a lock nut, or to provide an attachment method to the self-drilling anchor.

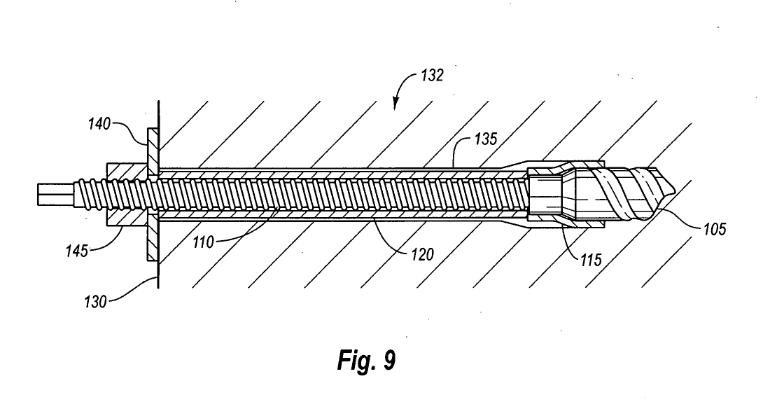

FIG. 9 illustrates an example of a self-drilling anchor that has been retained. A plate 140 is located over the drill rod 110. The plate 140 can be a separate component or can be part of another piece of equipment. The plate 140 will sit flush, or nearly flush, against the surface 130 of the medium 132. The plate 140 can provide a flat surface for the other retaining elements. The plate 140 can also hold the drill rod 110 from moving. Within the drill hole 135, the rod sleeve 120 may prevent lateral movement. However, the rod sleeve 120 may not extend to the surface. In some embodiments, the diameter of the hole 135 in the plate 140 is nearly the same as the outside diameter of the drill rod 110, preventing movement of the drill rod 110 with respect to the plate 140. In other embodiments, the plate 140 can contain a complementary hole 135 to the shape of the drill rod 110, allowing the plate 140 to be fit tightly around the drill rod 110. For example, the plate 140 can have threading which allows the plate 140 to be threaded onto the drill rod 110. Once the plate 140 is secured, friction between the plate 140 and the surface 130 of the medium 132 will prevent movement of the plate 140, which in turn prevents lateral movement of the drill rod 110.

A nut 145 is threaded onto the drill rod 110 and the nut 145 is tightened until the nut 145 is flush, or nearly flush, against the plate 140 and the plate 140 is flush, or nearly flush, against the surface 130 of the medium 132. Tightening the nut 145 can prevent lateral movement of the self-drilling anchor. Frictional forces between the plate 140 and the surface 130 of the medium 132, and the nut 145 and the plate 140, can prevent movement of the drill rod 110. Additionally, tightening the nut 145 can make the anchor more secure. As the nut 145 is tightened against the plate 140, the forces involved will pull the drill rod 110 out of the hole 135 if the anchor has not been secured well. This will, in turn, pull the drill bit 105 more securely into the expansion shell 115. If the expansion shell 115 slides with the drill bit 105, the expansion shell 115 may eventually pull into the rod sleeve 120, which will, in turn, pull into the plate 140, preventing further sliding. The result will be the expansion shell 115 more firmly wedged between the drill bit 105 and the medium 132, making the self-drilling anchor more secure.

In some embodiments, a second nut (not shown) can be threaded onto the drill rod 110 and tightened against the first nut 145, acting as a lock nut. Alternatively, other attachments, such as a hook, an eyelet, or any other attachment can be threaded or otherwise attached to the protruding end of the drill rod 110 either to serve as a locking mechanism, such as a lock nut, or to provide an attachment method to the self-drilling anchor.

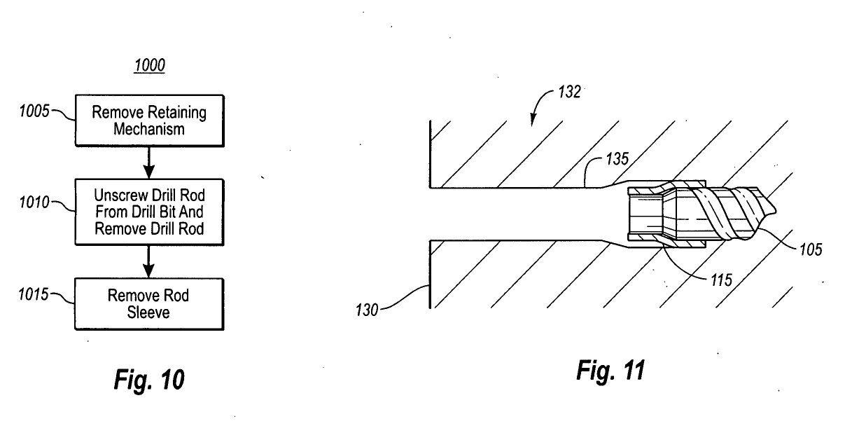

FIG. 10 illustrates a method 1000 for removing some of the components of the self-drilling anchor. Removal of components eliminates waste because the removed components can be reused in other self-drilling anchors or in other applications. Removal of components also reduces cost, since some or all components can be used in other installations. Removal of components can also minimize the amount of residual materials left in the medium 132. In some embodiments, such as mining operations, minimizing the residual material can decrease the likelihood of digging into the anchor. Digging into the anchor can create a safety hazard if residual material is not minimized. In other embodiments, such as where the self-drilling anchor has been installed in a road bed, minimizing the amount of residual material can protect vehicle tires and other equipment.

The method 1000 includes removing 1005 the retaining mechanism, if any. The retaining mechanism may be removed by removing the second nut or other attachments if present. The first nut 145 may be removed by unthreading the nut 145 from the drill rod 110. The plate 140 may then be removed, or unthreaded, as applicable, from the drill rod 110.

The method 1000 also includes unscrewing 1010 the drill rod 110 from the drill bit 105 and removing the drill rod 110. In some embodiments, a drill, or other device, may be attached to the driver on the second end 110B of the drill rod 110 and run in reverse. Because the expansion shell 115 is wedged between the drill bit 105 and the medium 132, the drill bit 105 may be prevented from rotating and reversing out of the hole 135. Therefore, the torque provided by the drill, or other device, will serve to unscrew the drill rod 110 from the drill bit 105. The drill rod 110 may then be pulled from the hole 135 to be reused in another application.

In other embodiments, removing 1005 the retaining mechanism and unscrewing 1010 the drill rod 110 from the drill bit 105 and removing the drill rod 110 may be performed in a single step. The first nut 145 is loosened using a stillson wrench, pipe wrench, or any other wrench or tool that can be used to loosen the nut 145. If a locknut is present, the locknut binds the first nut 145 and transmits the applied movement to the drill rod 110. This loosens, and eventually removes, the drill rod 110 from the drill bit 105, which remains secured in the medium 132. The retaining mechanism and drill rod 110 may then be pulled from the hole 135 to be reused in another application.

The method 1000 further includes removing 1015 the rod sleeve 120, if present. In some embodiments, the sleeve may be simply pulled from the hole 135. In other embodiments, a tool, such as needle-nose pliers, may be needed to provide a mechanism for gripping the rod sleeve 120 to facilitate removal of the rod sleeve 120. In further embodiments, the drill rod 110 may have some mechanism, such as a collar or other mechanism, for removing the rod sleeve 120 with the drill rod 110. In other embodiments, the rod sleeve 120 may not be removed, and may instead be left in the hole 135.

FIG. 11 shows a self-drilling anchor in which the retaining mechanism, drill rod 110 and rod sleeve 120 have been removed. The drill bit 105 and expansion sleeve remain within the medium 132. In some embodiments, they can be used in a self-drilling anchor at a later time, such as if there has been damage to the retaining mechanism or drill rod 110 and they are being replaced. In other embodiments, they may be left indefinitely within the medium 132 without further use.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A self-drilling anchor, comprising:
a drill rod wherein the drill rod has a first end and a second end;
a drill bit wherein the drill bit is attached to the first end of the drill rod;
an expansion shell wherein the expansion shell is located over the drill rod near the first end and adjacent to the drill bit; and
a rod sleeve wherein the rod sleeve is located over the drill rod and adjacent to the expansion shell.

2. A self-drilling anchor according to claim 1, wherein the drill rod has threads disposed over all or part of its length.

3. A self-drilling anchor according to claim 2, wherein the thread size on the drill rod is R25.

4. A self-drilling anchor according to claim 2, wherein the thread includes a left-handed thread.

5. A self-drilling anchor according to claim 1, wherein the drill rod includes a driver on the second end.

6. A self-drilling anchor according to claim 5, wherein the driver is hex shaped.

7. A self-drilling anchor according to claim 5, wherein the driver is attached via a coupling.

8. A self-drilling anchor according to claim 1, wherein the drill bit includes a shank with an integral taper.

9. A self-drilling anchor according to claim 8, wherein the expansion shell has an inside diameter that exceeds the smallest outside diameter of the shank of the drill bit.

10. A self-drilling anchor according to claim 1, wherein the expansion shell includes a split along at least a portion of its length.

11. A self-drilling anchor according to claim 1, wherein the expansion shell includes a material sufficiently rigid to be driven between the drill bit and a medium by a force transmitted through the sleeve.

12. A self-drilling anchor according to claim 1, further comprising:
a drive sleeve located over the second end of the drill rod and adjacent to the rod sleeve.

13. A self-drilling anchor according to claim 8, wherein the drive sleeve includes a closed end.

14. A method for assembling a self-drilling anchor, comprising:
providing a drill rod having a first end and a second end;
attaching a drill bit to the first end of the drill rod;
locating an expansion shell over the drill rod near the first end and adjacent to the drill bit; and
locating a rod sleeve over the drill rod and adjacent to the expansion shell.

15. A method for assembling a self-drilling anchor according to claim 14, further comprising:
locating a drive sleeve over the second end of the drill rod and adjacent to the rod sleeve.

16. A method for assembling a self-drilling anchor according to claim 14, wherein the drill rod includes a driver on the second end.

17. A method for assembling a self-drilling anchor according to claim 16, wherein the driver is attached via a coupling.

18. A method for installing a self-drilling anchor, comprising:
assembling a self-drilling anchor according to claim 14;
driving the self-drilling anchor to a desired depth in a medium; and
securing the self-drilling anchor at the desired depth.

19. A method for installing a self-drilling anchor according to claim 18, wherein the expansion shell is located over the drill rod after driving the self-drilling anchor to the desired depth.

20. A method for installing a self-drilling anchor according to claim 19, wherein the rod sleeve is located over the drill rod after driving the self-drilling anchor to the desired depth.

21. A method for installing a self-drilling anchor according to claim 18, wherein driving the self-drilling anchor includes attaching a drill to the second end of the drill rod.

22. A method for installing a self-drilling anchor according to claim 18, wherein securing the anchor includes supplying force to the rod sleeve until the expansion shell is wedged between the drill bit and the medium.

23. A method for installing a self-drilling anchor according to claim 22, wherein supplying force to the rod sleeve includes:
locating a drive sleeve over the second end of the drill rod and adjacent to the rod sleeve; and
supplying force to the drive sleeve.

24. A method for installing a self-drilling anchor according to claim 18, further comprising:
retaining the self-drilling anchor.

25. A method for installing a self-drilling anchor according to claim 24, wherein retaining the self-drilling anchor includes:
placing a plate over the drill rod and against the surface of the medium;
threading a nut onto the drill rod; and
tightening the nut against the plate.

26. A method for installing a self-drilling anchor according to claim 25, further comprising:
threading an attachment onto the drill rod.

27. A method for installing a self-drilling anchor according to claim 26, further comprising:
threading a second nut onto the drill rod; and
tightening the second nut against the first nut.

28. A method for installing a self-drilling anchor according to claim 18, further comprising:
removing the drill rod.

29. A method for installing a self-drilling anchor according to claim 28, further comprising:
removing the rod sleeve.
